(19) United States
(12) Patent Application Publication
(10) Pub. No.: US 2026/0292865 A1
(43) Pub. Date: Sep. 24, 2026

(54) ELECTRONIC DEVICE AND METHOD USED FOR NETWORK SIDE AND TERMINAL DEVICE SIDE IN WIRELESS COMMUNICATION

(71) Applicant: Sony Group Corporation, Tokyo (JP)

(72) Inventor: Lantao LI, Beijing (CN)

(73) Assignee: Sony Group Corporation, Tokyo (JP)

(21) Appl. No.: 19/167,875

(22) PCT Filed: May 6, 2024
(86) PCT No.: PCT/CN2024/091144

§ 371 Date: Sep. 23, 2025

(30) Foreign Application Priority Data
May 10, 2023 (CN) 202310521895.2

(51) Int. Cl. H04W 72/56; H04W 4/44; H04W 4/46; H04W 24/02

(52) U.S. Cl. CPC H04W 72/56; H04W 4/44; H04W 4/46; H04W 24/02

(57) ABSTRACT

The present disclosure provides an electronic device and method used for a network side and a terminal device side in wireless communication, and a computer-readable storage medium. The electronic device used for a network side comprises: a processing circuit, configured to: in response to an assistance request related to near-field communication from a terminal device, determine indication information for the terminal device on the basis of sensing information; and provide the indication information for the terminal device.

This application claims priority to Chinese Patent Application No. 202310521895.2 titled “ELECTRONIC DEVICE AND METHOD USED FOR NETWORK SIDE AND TERMINAL DEVICE SIDE IN WIRELESS COMMUNICATION”, filed on May 10, 2023 with the China National Intellectual Property Administration, which is incorporated herein by reference in its entirety.

### FIELD

The present disclosure relates to the field of wireless communications, and in particular to perception-based near field communication assistance technology, and more particularly to an electronic apparatus and a method for a network side and a terminal device side in wireless communications, and a computer-readable storage medium.

### BACKGROUND

With the maturity of perception technology, especially computer vision technology, various types of sensors (such as cameras, LiDAR, millimeter-wave radar, radio frequency perception devices, gravity sensors, infrared sensors, and ultrasonic sensors) equipped on smart connected vehicles, drones, and XR devices enable these devices to have an ability of perceiving a surrounding environment, including but not limited to the abilities of classifying and identifying objects, measuring (such as distance measurement, size measurement, speed measurement), and segmentation. On the other hand, it is noted that some perception technologies developed based on radio frequency are developing rapidly. Standard research organizations such as 3GPP and IMT-2030 have begun to discuss that base stations/intelligent terminal devices perceive the surrounding environment (e.g. recognizing a gesture, a human body posture, or a vehicle speed) by transmitting or receiving radio frequency signals through antennas for communications, so that the base stations/intelligent terminal devices will have innate perception capabilities in the future. In addition, some non-radio frequency sensor sources may be deployed at the base stations.

At present, 5G devices, especially 5G devices in China, have not yet involved use of millimeter wave frequency bands. One of the important factors is that the channel/communication performance in the millimeter wave frequency band is easily affected by environmental factors. For example, the transmitted beam may easily be blocked by vehicles, trees, buildings, signs and even human bodies. Such problem is particularly prominent in the Internet of Vehicles.

### SUMMARY

Hereinafter provided is a brief summary of the present disclosure, which is intended to provide a basic understanding of aspects of the present disclosure. It should be understood that this summary is not an exhaustive overview of the present disclosure. The summary is not intended to identify key or critical portions of the present disclosure or to delineate the scope of the present disclosure. The purpose is merely to present some concepts in a simplified form, as a prelude to the more detailed description that is presented later.

According to an aspect of the present disclosure, an electronic apparatus for a network side in wireless communications is provided. The electronic apparatus includes processing circuitry configured to: in response to an assistance request about Near Field Communication from a terminal device, determine indication information for the terminal device based on perception information; and provide the indication information to the terminal device.

According to another aspect of the present disclosure, a method for a network side in wireless communications is provided. The method includes: in response to an assistance request about Near Field Communication from a terminal device, determining indication information for the terminal device based on perception information; and providing the indication information to the terminal device.

According to an aspect of the present disclosure, an electronic apparatus for a terminal device side in wireless communications is provided. The electronic apparatus includes processing circuitry, configured to: transmit an assistance request about Near Field Communication to a network side in the wireless communications; and acquire, from the network side, indication information for the terminal device which is determined by the network side based on perception information in response to the assistance request.

According to another aspect of the present disclosure, a method for a terminal device side in wireless communications is provided. The method includes: transmitting an assistance request about Near Field Communication to a network side in the wireless communications; and acquiring, from the network side, indication information for the terminal device which is determined by the network side based on perception information in response to the assistance request.

According to other aspects of the present disclosure, computer program codes and a computer program product for implementing the above-described methods for a network side and a terminal device side in wireless communications and a computer-readable storage medium having the computer program codes for implementing the methods for a network side and a terminal device side in wireless communications stored thereon are further provided.

With the electronic apparatus and method according to the embodiments of the present disclosure, an assistance operation for the Near Field Communication is provided based on the perception information, thereby enabling the terminal device to adapt to changes in a wireless environment, so that a continuity of services of the terminal device and adaptability to the environment are enhanced.

These and other advantages of the present disclosure become more apparent through preferred embodiments of the present disclosure described in detail below in conjunction with accompany drawings.

### BRIEF DESCRIPTION OF THE DRAWINGS

For a further illustration of the above and other advantages and features of the present disclosure, embodiments of the present disclosure are described in detail hereinafter in conjunction with accompanying drawings. The drawings, together with the detailed description below, are incorporated into and form a part of the specification. Elements having the same function and structure are denoted by same reference signs. It should be noted that the drawings illustrate merely typical embodiments of the present disclosure and should not be construed as a limitation to the scope of the present disclosure. In the drawings:

FIG. 1 illustrates a schematic diagram of a communication scenario in Internet of Vehicles as an example;

FIG. 2 illustrates an abstract schematic diagram of distribution of user equipment near an intersection and Near Field Communication;

FIG. 3 is a block diagram illustrating functional modules of an electronic apparatus for a network side in wireless communications according to an embodiment of the present disclosure;

FIG. 4 illustrates an example of an enhanced Internet of vehicles service application architecture defined by CCSA;

FIG. 5 illustrates a schematic diagram of a training process of a neural network model;

FIG. 6 illustrates an example of a flow chart of perception-assisted Near Field Communication;

FIG. 7 illustrates an example of a flow chart of perception-assisted Near Field Communication in the enhanced Internet of vehicles service application architecture defined by CCSA;

FIG. 8 illustrates another example of a flow chart of perception-assisted Near Field Communication in the enhanced Internet of vehicles service application architecture defined by CCSA;

FIG. 9 is a block diagram illustrating functional modules of an electronic apparatus for a terminal device side in wireless communications according to another embodiment of the present disclosure;

FIG. 10 is a block diagram illustrating functional modules of an electronic apparatus for a terminal device side in wireless communications according to another embodiment of the present disclosure;

FIG. 11 illustrates a flow chart of a method for a network side in wireless communications according to an embodiment of the present disclosure;

FIG. 12 illustrates a flow chart of a method for a terminal device side in wireless communications according to another embodiment of the present disclosure;

FIG. 13 is a block diagram illustrating an example of a schematic configuration of a server;

FIG. 14 is a block diagram showing a first example of a schematic configuration of an eNB or gNB to which the technology of the present disclosure is applicable;

FIG. 15 is a block diagram showing a second example of a schematic configuration of an eNB or gNB to which the technology of the present disclosure is applicable;

FIG. 16 is a block diagram showing an example of a schematic configuration of a smart phone to which the technology of the present disclosure is applicable;

FIG. 17 is a block diagram showing an example of a schematic configuration of an automobile navigation device to which the technology of the present disclosure is applicable; and

FIG. 18 is a block diagram of an exemplary structure of a general-purpose personal computer in which a method and/or apparatus and/or system according to an embodiment of the present disclosure may be implemented.

### DETAILED DESCRIPTION

Exemplary embodiments of the present disclosure are described below in conjunction with the drawings. For the sake of clarity and conciseness, not all features of an actual embodiment are described in the specification. However, it is to be appreciated that numerous implementation-specific decisions shall be made while implementing any of such actual embodiments so as to achieve specific objectives of a developer, for example, to comply with system-and service-related constraining conditions which vary from one implementation to another. Furthermore, it should be understood that the development work, although may be complicated and time-consuming, is only a routine task for those skilled in the art benefiting from the present disclosure.

Here, it should be further noted that in order to avoid obscuring the present disclosure due to unnecessary details, only apparatus structures and/or processing steps closely related to the solutions according to the present disclosure are illustrated in the drawings, and other details less related to the present disclosure are omitted.

### First Embodiment

For example, in a case where a terminal device uses a millimeter wave band for communications, in order to reduce an impact of environmental factors on communication performance, various objects in the environment that may cause obstructions may be identified and marked. Then, processing may be performed, such as prompting handover of a relevant terminal device, beam adjustment, QoS adjustment, radio frequency identification, and other operations. The identification and marking may be performed by taking advantage of the sensing advantages of terminal devices, base stations, third-party sensors, and the like.

In the embodiment, an electronic apparatus 100 is provided, which is configured to assist the Near Field Communication of a terminal device by using perception information, thereby improving adaptability of the electronic apparatus to an environment. In the description below, the Internet of Vehicles is mainly described an exemplary scenario. It should be understood that this is not restrictive. The technical solution in the present disclosure applies to other scenarios with similar requirements, such as XR communications and drone communications. In addition, the Near Field Communication here includes but is not limited to D2D communication or sidelink communication, and is not limited to the millimeter wave band. The terminal device is any communication device capable of performing Near Field Communication, and the following description is made with user equipment (UE) as an example.

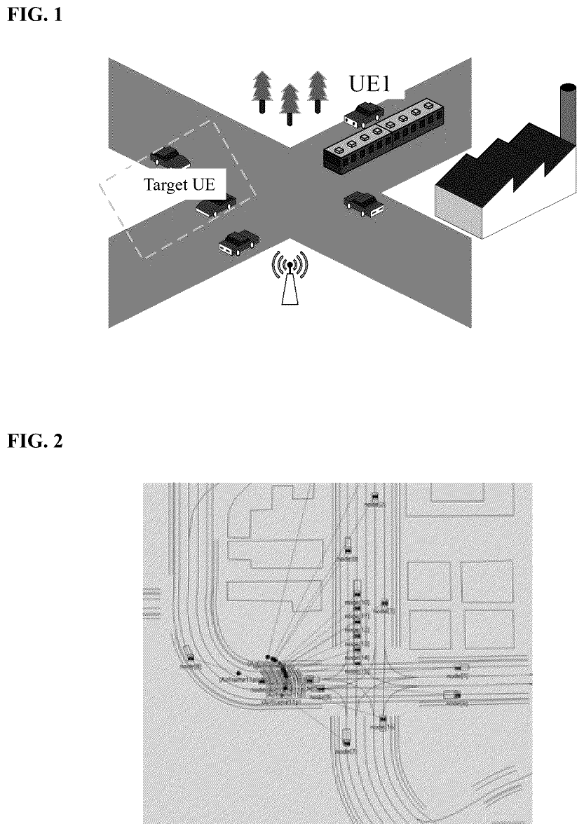

For ease of understanding, FIG. 1 illustrates a schematic diagram of a communication scenario in Internet of Vehicles as an example. In the figure, UE 1 represents a terminal device with a demand for Near Field Communication, and target UE represents a terminal device that possibly performs Near Field Communication with UE 1. FIG. 2 illustrates an abstract schematic diagram of distribution of UEs near an intersection and Near Field Communication. For example, before passing an intersection, UE 1 finds itself blocked by a building nearby. Therefore, in order to predict or sense the surrounding environment, UE 1 hopes that the network side assists in Near Field Communication so as to quickly and reliably establish a sidelink connection and receive required information from another terminal device through the sidelink connection, such as perception information collected by another terminal device, which may be used for autonomous driving, for example.

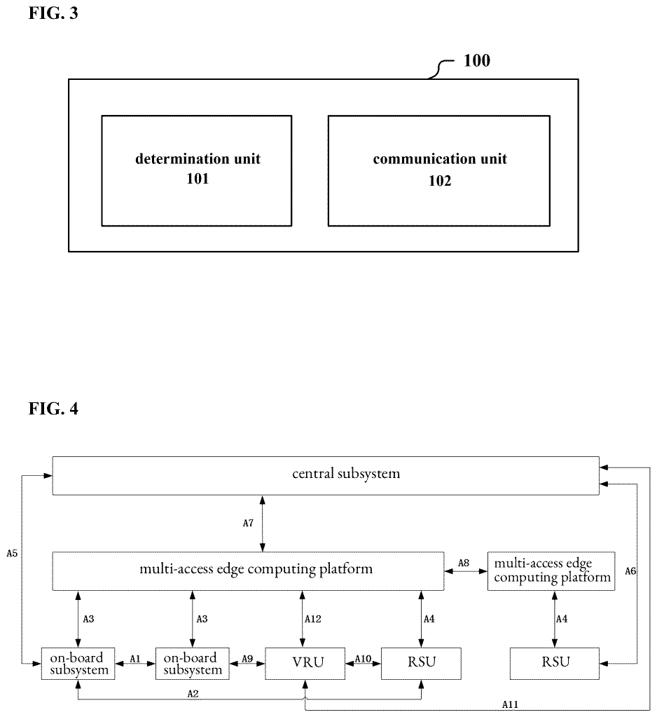

FIG. 3 is a block diagram illustrating functional modules of an electronic apparatus 100 for a network side in wireless communications according to an embodiment of the present disclosure. As shown in FIG. 3, the electronic apparatus 100 includes a determination unit 101 and a communication unit 102. The determination unit is configured to, in response to an assistance request about Near Field Communication from a terminal device, determine indication information for the terminal device based on perception information. The communication unit is configured to provide the indication information to the terminal device.

The determination unit 101 and the communication unit 102 may be implemented by one or more processing circuits. The processing circuitry may be implemented as a chip or a processor, for example. It should be understood that various functional units in the electronic apparatus shown in FIG. 3 are only logical modules determined based on specific functions thereof, and are not intended to limit a specific implementation.

The electronic apparatus 100 may be disposed on a network side, a cloud server side or an edge server side. The network side may, for example, include one of a core network or a base station side. In addition, in the example of the enhanced Internet of Vehicles service application architecture defined by CCSA as shown in FIG. 4, the electronic apparatus 100 may be disposed in one or more of a central subsystem, a roadside unit (RSU) or a multi-access edge computing platform (MEC).

Functional entities in FIG. 4 are briefly described as follows. The on-board subsystem has abilities of communicating (based on 4/5G cellular wireless communication, 4/5G cellular sidelink communication), storing and processing local data, and perceiving driving environment information. The on-board subsystem can transmit the perceived information to the roadside unit (RSU), the multi-access edge computing platform, and the central subsystem, and can receive and process application layer information sent from the roadside unit, the multi-access edge computing platform, and the central subsystem. The roadside unit has road-side perception and communication (based on 4/5G cellular wireless communication and 4/5G cellular sidelink communication) abilities and can transmit the perceived information to the on-board subsystem. The multi-access edge computing platform and the central subsystem are capable of receiving application layer information sent from the on-board subsystem, the multi-access edge computing platform and the central subsystem. The multi-access edge computing platform has multi-access ability and local service processing ability, and can receive and process perception information from multiple sources, output a local service control strategy according to requirements of the service, and output the strategy to the on-board subsystem and the roadside unit. The multi-access edge computing platform can collaborate with other multi-access edge computing platforms to process perception data and control data, and can collaborate with the central subsystem to support evolution of the Internet of Vehicles. The central subsystem has an ability of communicating with the on-board subsystem, the roadside unit, and the multi-access edge computing platform, and an ability of receiving, storing, processing and distributing global data. The central subsystem is responsible for global information perception and global service strategy control. A vulnerable traffic participant (VRU) has an ability of communication, and is able to transmit data and information such as location, speed, travel direction, and trajectory of the vulnerable traffic participant (VRU) to the on-board subsystem, the roadside unit, the central subsystem, and the multi-access edge computing platform. The vulnerable traffic participant (VRU) is able to receive application layer information sent from the on-board subsystem, the roadside unit, the multi-access edge computing platform, and the central subsystem.

The electronic apparatus 100 of the embodiment may be disposed in the central subsystem, or in the RSU and MEC, and an example of a specific information flow is given later.

It should be noted that the electronic apparatus 100 may be implemented at a chip level or at a device level. For example, the electronic apparatus 100 may operate as the base station itself and may further include a memory, a transceiver (not shown), and other external devices. The memory may store related data information and programs that the base station needs to execute to achieve various functions. The transceiver may include one or more communication interfaces to support communications with different devices (such as another base station, a UE, and the like). An implementation of the transceiver is not specifically limited here. Furthermore, the electronic apparatus 100 may operate as a server.

For example, referring to the scenario shown in FIG. 1, the assistance request may come from UE 1. For example, the communication unit 102 receives or acquires the assistance request from UE 1. The assistance request is for requesting the network side to provide information required for preparing the Near Field Communication between the terminal device (UE 1) and another terminal device (another UE). Generally, the network side usually has perception information which is more global and complete. The perception information may be used for provide the terminal device with a more reasonable suggestion or decision of Near Field Communication. Therefore, when there is a need, for example, when detecting that an object affecting the wireless environment is around the terminal device, the terminal device requests the network side for assistance in Near Field Communication based on perception information, thereby reducing the impact of the environment on wireless transmission.

For example, the assistance request may include one or more of a geographic location, a planned path, a blind zone in perception, a priority level of tendency for a perception service category, and a format of the indication information for the terminal device. Information on the geographical location, the planned path and the blind zone in perception for the terminal device enables the network side to select appropriate perception information more specifically. The perception service category includes, for example, perception raw data fusion, feature map fusion, and perception message sharing, which correspond to different precisions. The priority level of tendency for the perception service category is for indicating a perception service category preferred by the terminal device. The format of the indication information represents a format or content of the indication information that the terminal device expects to receive, that is, is for informing the network side of a form of assistance that the terminal device expects the network side to provide. Examples of a format or content of the indication information are described below.

For example, the indication information may include one or more of perception information for the terminal device, information on a strategy of the Near Field Communication for the terminal device, information on a region of the Near Field Communication for the terminal device, and relevant information of another potential terminal device meeting the requirements of the terminal device.

The perception information may include one or more of raw sensor data, dynamic high-precision map, feature data or semantic data, and communication semantics or features. The raw sensor data may be, for example, a point cloud image generated by a LiDAR, image information captured by a camera, or a waveform captured by a radio frequency antenna. The dynamic high-precision map is generated or updated based on the raw sensor data, and includes information such as location, size, mobility data and other information of various identified objects in a coordinate system of the dynamic high-precision map. Feature data or semantic data is, for example, a feature map or semantic information generated after processing the above-mentioned raw sensor data or raw sensor data obtained from other sensor sources. For example, the feature data or semantic data may be feature images in different dimensions such as shape feature, color feature, material feature and size feature of an object, for integrating advantages of various types of sensors to form a comprehensive perception of the environment. The communication semantics or features correspond to features or semantic parameters of the sensing information, such as features or semantics of a communication environment and channels.

The network-side device may receive sensor data from the terminal device and/or a third-party sensor (for example, a camera near the base station). In addition, the network-side device, such as a base station, may have perception ability. The sensor data together constitute or generate the perception information.

Specifically, for example, the terminal device may sense the surrounding environment with its sensors to obtain perception data, and record and measure the communication to obtain communication status data. The terminal device may directly provide raw sensor data as the perception information, or may process or fuse the raw sensor data to obtain the perception information in other forms as mentioned above. The communication status data may include, for example, communication quality at that time, such as QoS parameters (packet loss rate, rate, delay parameter, and the like), signal strength (reference signal reception strength, reference signal reception power), and the like; communication settings of terminal devices participating in the communication, such as transmission strength of signal/beam, direction and range of a beam; and physical information of terminal devices participating in the communication, such as location, orientation, or mobility information (moving direction, moving speed). The terminal device may process the communication status data to obtain simplified communication information, for example, marking the current communication status as a communication quality corresponding to a specific direction/specific target location or whether a connection exists. The obtained perception information and communication information are transmitted by the terminal device to a base station, and then provided by the base station to a core network. In addition, the base station may transmit the perception information and communication information thereof to the core network. The core network may fuse and process various received information.

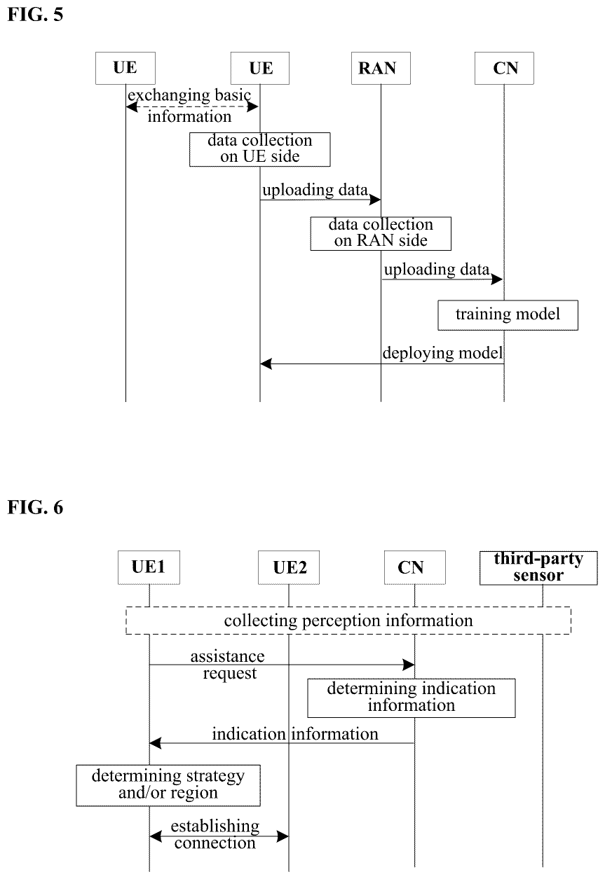

For example, the core network may perform training based on sensor data from at least one of the network side, the terminal device or a third-party sensor to obtain a neutral network model (AI model). The neural network model may be used for predicting quality of wireless communications, or further for predicting a wireless communication strategy to be adopted. In the embodiment, the neural network model may be used for Near Field Communication assistance. The trained neural network model (or a part thereof) may be deployed on the core network side, the base station side or the terminal device side. For ease of understanding, FIG. 5 illustrates a schematic diagram of a training process of the neural network model. In FIG. 5, sidelink communication is performed between UEs, a radio access network (RAN) represents a base station, for example, and CN represents a core network side.

For example, an input of the neural network model may be perception information, and an output may be a predict result of communication quality or a predict result of communication strategy. The neural network model may correspond to a specific scenario category (such as a fixed wireless environment category or a non-fixed wireless environment category), or may be a general model with universal applicability to all scenario categories.

In a case where the indication information is perception information for the terminal device, the terminal device may generate a strategy of Near Field Communication and/or region of Near Field Communication for the terminal device based on the perception information by using the neural network model.

In addition, the indication information may be information on a strategy of Near Field Communication for the terminal device and/or information on a region of Near Field Communication for the terminal device. In this case, the neural network model is run on the network side. The determination unit 101 may be configured to predict the strategy of the Near Field Communication and/or the region of the Near Field Communication for the terminal device based on the perception information and the assistance request by using a neural network model disposed on the network side.

For example, the strategy of the Near Field Communication may include one or more of Near Field Communication manner, an identifier of a Near Field Communication object, a priority level of the Near Field Communication object, mobility information of the Near Field Communication object, available communication time corresponding to the Near Field Communication object, expected communication quality, service content of the Near Field Communication, and requirements of the Near Field Communication. The Near Field Communication manner includes, for example, direct communication and relay communication. The identifier of a Near Field Communication object is, for example, layer-2 ID, IMSI/GUTI, or the like. The mobility information of the Near Field Communication object includes, for example, a location, a moving speed, or a planned path of the object. The available communication time corresponding to the Near Field Communication object includes, for example, a start time point and an end time point of the communication. The expected communication quality includes, for example, QoS. The service content of the Near Field Communication, for example, indicates whether to initiate sensing fusion or message-level perception sharing. The requirements of the Near Field Communication include, for example, a triggering time and termination time of the communication service, a transmission requirement of the communication service, a plan for establishing multiple Near Field Communication connections (for example, triggering actual establishment by a geographic location), or a service quality level. The terminal device may perform the Near Field Communication based on the received strategy of Near Field Communication, for example, determining a Near Field Communication object and establishing a connection therewith.

For example, the region of the Near Field Communication may include one or more of a first target region (electronic fence) where another terminal device suitable for conducting the Near Field Communication with the terminal device is located, boundary region information of the first target region, and a second target region where the terminal device is suitable for triggering the Near Field Communication and an upper-layer service. The region of Near Field Communication may correspond to an effective time range. For example, within a relatively long time range, the wireless environment of the region of Near Field Communication is not interfered by other objects (considering mobility of other objects). Information on the effective time range may be included in the information on the region of Near Field Communication. It can be seen that the region of Near Field Communication may be used for setting a triggering condition for the Near Field Communication. The terminal device may search for a suitable Near Field Communication object based on the received region of Near Field Communication (for example, in the first target region), and establish a connection with the object. The terminal device is, for example, a vehicle in the Internet of Vehicles.

In addition, the indication information may further include relevant information of another potential terminal device meeting the requirements of the terminal device. For example, the network side may provide such indication information to the terminal device in a case where no communication object is determined for the terminal device. The relevant information of a potential terminal device may include, for example, one or more of the identifier, mobility information, priority level, and available communication time of the potential terminal device. The indication information may be further provided by the network side to a specific terminal device and provided by the specific terminal device to the discussed terminal device.

For ease of understanding, FIG. 6 illustrates an example of a flow chart of perception-assisted Near Field Communication. In this example, the electronic apparatus 100 is located on a core network (CN) side, for example. First, UE, CN and a third-party sensor collect perception information to obtain a trained neural network model. Next, UE 1 needs assistance in Near Field Communication and thus transmits an assistance request to CN. Based on the perception information and the assistance request, CN determines indication information for UE 1 by using the neural network model. The indication information is, for example, information on a strategy of Near Field Communication and/or a region of Near Field Communication. UE 1 determines the strategy of Near Field Communication and/or region of Near Field Communication to be executed by itself based on the indication information, and triggers a request for Near Field Communication with UE 2 as a Near Field Communication object and establishes a connection with UE 2.

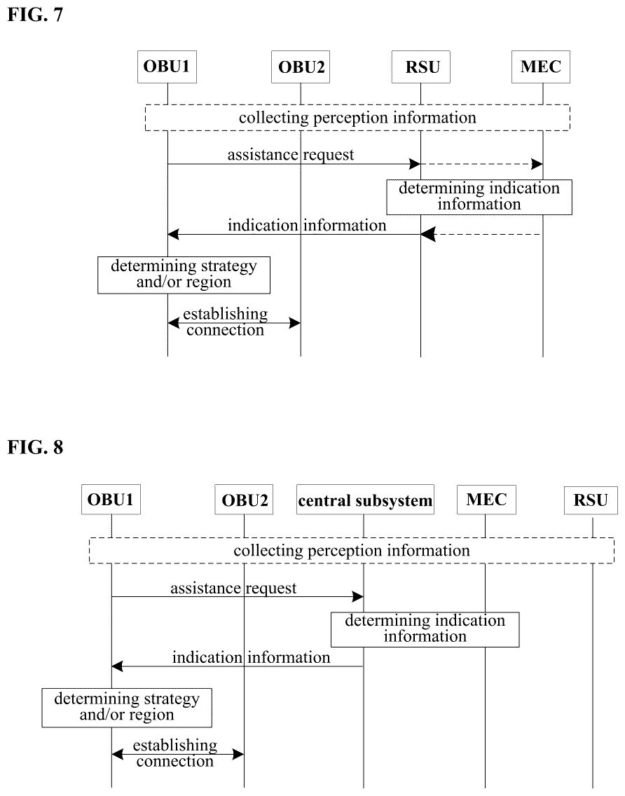

FIG. 7 illustrates an example of a flow chart of perception-assisted Near Field Communication in the enhanced Internet of vehicles service application architecture defined by CCSA. In the figure, the on-board unit (OBU) is equivalent to the on-board subsystem shown in FIG. 4, representing the terminal device in the embodiment; and RSU and MEC may serve as two physically separated entities, or mat be implemented in a same physical entity device (RSCU). In this example, the RSU and the MEC replace the CN in FIG. 6 to perform the functions of the electronic apparatus 100. The RSU itself may be regarded as a third-party sensor. First, OBU, RSU and MEC collect perception information to obtain a trained neural network model. Next, OBU 1 needs assistance in Near Field Communication and thus transmits an assistance request to RSU or MEC. It should be noted that in a case where RSU and MEC are not integrated as a single device, no matter the receiver is the RSU or the MEC, RSU is the functional entity that actually receives the assistance request, and the RSU may transmit the assistance request to the MEC. Based on the perception information and the assistance request, RSU and MEC determines indication information for OBU 1 by using the neural network model. The indication information is, for example, information on a strategy of Near Field Communication and/or a region of Near Field Communication. In a case where the RSU does not have an ability of processing perceived data, when the receiver is the RSU, the RSU may request indication information from the MEC. In this case, the RSU may be regarded as a perception device and a communication device of MEC. OBU 1 determines the strategy of Near Field Communication and/or the region of Near Field Communication to be adopted by itself based on the indication information, and triggers a request for Near Field Communication with OBU 2 which is the Near Field Communication object and establishes a connection.

FIG. 8 illustrates another example of a flow chart of perception-assisted Near Field Communication in the enhanced Internet of vehicles service application architecture defined by CCSA. This example is different from the example shown in FIG. 7 in that the edge side device (RSU and MEC) is replaced by the central subsystem to receive the assistance request and determine the indication information. The other processes are similar to those in FIG. 6 and FIG. 7 and are not repeated here. In this example, since the central subsystem usually has a larger regional management scope than the edge side device, for example, the central subsystem may correspond to multiple MECs, the indication information determined by the central subsystem is more comprehensive. For example, the determined strategy of Near Field Communication includes a large number of Near Field Communication objects and trigger conditions. Especially for a cross-regional situation (such as a road section between two sets of RSU and MEC), the central subsystem is required to directly determine the indication information for the OBU. On the other hand, the indication information determined by the edge side device is more in line with the real-time requirements of OBU. It should be noted that although FIG. 8 shows that OBU may transmit a message directly to the central subsystem, the message is actually transmitted to the central subsystem through the edge side device or a core network gateway (a large network connected through a Uu port).

It should be noted that the information flows shown in FIG. 6 to FIG. 8 are merely exemplary and not restrictive.

In summary, with the electronic apparatus 100 according to the embodiments, an assistance operation for the Near Field Communication is provided based on the perception information, thereby enabling the terminal device to adapt to changes in a wireless environment, so that a continuity of services of the terminal device and adaptability to the environment are enhanced.

### Second Embodiment

FIG. 9 is a block diagram illustrating functional modules of an electronic apparatus 200 for a terminal device side in wireless communications according to another embodiment of the present disclosure. As shown in FIG. 9, the electronic apparatus 200 includes a transmission unit 201 and a reception unit 202. The transmission unit is configured to transmit an assistance request about Near Field Communication to a network side in the wireless communications. The reception unit is configured to acquire, from the network side, indication information for the terminal device determined by the network side based on perception information in response to the assistance request.

The transmission unit 201 and the reception unit 202 may be implemented by one or more processing circuits. The processing circuitry may be implemented as a chip or a processor, for example. It should be understood that various functional units in the electronic apparatus shown in FIG. 9 are only logical modules determined based on specific functions thereof, and are not intended to limit a specific implementation. The electronic apparatus 200 is located on the terminal device side. The terminal device here may be, for example, various UEs.

The electronic apparatus 200 may be implemented at a chip level or at an apparatus level. For example, the electronic apparatus 200 may operate as the terminal device itself and may further include a memory, a transceiver (not shown), and other external devices. The memory may store related data and information and programs that are required to be executed by the terminal device to implement various functions. The transceiver may include one or more communication interfaces to support communications with different devices (such as another terminal device, a base station, a core network, and the like). The implementation of the transceiver is not specifically limited here.

The transmission unit 201 may transmit the assistance request when needed. For example, the transmission unit 201 may transmit the assistance request in response to detecting that an object affecting a wireless environment is around the terminal device. For example, in the scenario shown in FIG. 1, UE 1 may transmit an assistance request when detecting an obstructing building around.

The assistance request is for requesting the network side to provide information required for preparing the Near Field Communication between the terminal device and another terminal device. For example, the assistance request may include one or more of a geographic location, a planned path, a blind zone in perception, a priority level of tendency for a perception service category, and a format of the indication information for the terminal device. Relevant details thereof are described in the first embodiment and are not repeated here.

For example, the indication information received by the reception unit 202 may include one or more of perception information for the terminal device, information on a strategy of the Near Field Communication for the terminal device, information on a region of the Near Field Communication for the terminal device, and relevant information of another potential terminal device meeting the requirements of the terminal device.

Similar to the first embodiment, depending on a degree and category of processing, the perception information may include one or more of raw sensor data, dynamic high-precision map, feature data or semantic data, and communication semantics or features.

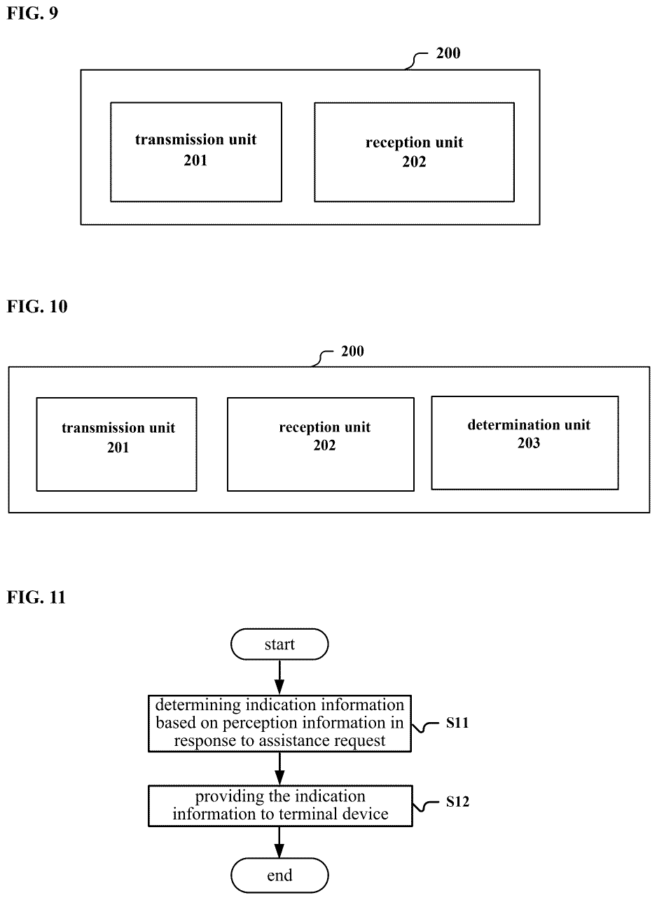

FIG. 10 illustrates another example of block diagram of functional modules of the electronic apparatus 200. In addition to the transmission unit 201 and the reception unit 202, the electronic apparatus 200 further includes a determination unit 203. For example, in a case where the indication information includes perception information for the terminal device, the determination unit 203 may generate a strategy of Near Field Communication and/or a region of Near Field Communication based on the perception information by using a neural network model. In this case, a neural network model distributed from the network side is disposed on the terminal device. Generation of the neural network model has been described in the first embodiment and applies to this embodiment.

In addition, the indication information may be information on a strategy of Near Field Communication and/or information on a region of Near Field Communication for the terminal device determined by the network side. In this case, for example, the strategy of the Near Field Communication and/or the region of the Near Field Communication for the terminal device is predicted by the network side based on the perception information and the assistance request by using a neural network model disposed on the network side.

For example, the strategy of the Near Field Communication may include one or more of Near Field Communication manner, an identifier of a Near Field Communication object, a priority level of the Near Field Communication object, mobility information of the Near Field Communication object, available communication time corresponding to the Near Field Communication object, expected communication quality, service content of the Near Field Communication, and requirements of the Near Field Communication.

The region of the Near Field Communication may include one or more of a first target region where another terminal device suitable for conducting the Near Field Communication with the terminal device is located, boundary region information of the first target region, and a second target region where the terminal device is suitable for triggering the Near Field Communication and an upper-layer service. It can be seen that the region of Near Field Communication may be used for setting a triggering condition for the Near Field Communication. The determination unit 203 may be configured to preferentially determine another terminal device within the first target region as the Near Field Communication object, and/or initiate Near Field Communication with another terminal device when the terminal device is in the second target region.

In addition, the indication information may further include relevant information of another potential terminal device meeting the requirements of the terminal device. For example, the network side may provide such indication information to the terminal device in a case where no communication object is determined for the terminal device. The relevant information of a potential terminal device may include, for example, one or more of the identifier, mobility information, priority level, and available communication time of the potential terminal device. Alternatively, the reception unit 202 may receive second indication information from another terminal device, the second indication information including relevant information of a potential terminal device meeting the requirements of the terminal device. The second indication information is provided by the network side to the another terminal device.

In a case where the indication information includes information on a strategy of Near Field Communication and/or information on a region of Near Field Communication for the terminal device, or in a case where the strategy of Near Field Communication and/or the region of Near Field Communication is determined by the terminal device based on the perception information, the determination unit 203 is further configured to trigger a request for Near Field Communication with the Near Field Communication object based on the strategy of Near Field Communication and/or the region of Near Field Communication. The request for Near Field Communication includes, for example, one or more of a time period during which data transmission is expected to occur, an indication of direction and range of a beam and information strength, and an edge indication of Near Field Communication.

The Near Field Communication may not need to be performed all the time. For example, in a case of the Internet of Vehicles, a vehicle serving as the terminal device may need to trigger the Near Field Communication with sensing fusion only when there may be a risky object in the visual blind zone or the blind zone is far away. Therefore, the request for Near Field Communication may include a time period during which data transmission is expected to occur, so that efficiency of the Near Field Communication is improved.

In addition, the request for Near Field Communication may further include an indication of direction and range of a beam and information strength, so that the other terminal device is able to preliminarily determine an approximate direction and distance of the beam. Hence, the scanning range is narrowed and the time required for beam scanning is reduced.

The edge indication of Near Field Communication may include geographic information of an edge of the region of Near Field Communication and a communication behavior when approaching the edge, and the Near Field Communication object is configured to trigger, when reaching the edge, the communication behavior when approaching the edge. For example, the communication behavior when approaching the edge may include one or more of disconnecting a link, sending an alarm notification, increasing transmission power, and triggering beam adjustment.

Accordingly, the Near Field Communication object performs, according to information in the received request for Near Field Communication, at least one of determining an initial beam scanning range and a signal transmission strength for performing beam matching with the terminal device; determining a cycle for maintaining a keep-alive procedure and a configuration of wireless air interface resources; and triggering, when reaching the edge, the communication behavior when approaching the edge according to geographical information of the edge of the region of Near Field Communication and the communication behavior when approaching the edge indicated in the request for Near Field Communication.

Here, the reception unit 202 may be further configured to receive a request for Near Field Communication from another terminal device, and the determination unit 203 is configured to perform, in response to the request for Near Field Communication, at least one of determining an initial beam scanning range and a signal transmission strength for performing beam matching with the another terminal device; determining a cycle for maintaining a keep-alive procedure and a configuration of wireless air interface resources; and triggering, when reaching the edge, the communication behavior when approaching the edge according to geographical information of the edge of the region of Near Field Communication and the communication behavior when approaching the edge indicated in the request for Near Field Communication.

A relevant information flow is given with reference to FIG. 6 to FIG. 8 in the first embodiment and is not repeated here.

In summary, with the electronic apparatus 200 according to the embodiment, the Near Field Communication is performed on the network side based on assistance of the indication information provided from the perception information, thereby enabling the terminal device to adapt to changes in a wireless environment, so that a continuity of services of the terminal device and adaptability to the environment are enhanced.

### Third Embodiment

In the description of the electronic apparatuses for a network side and a terminal device side in wireless communications in the above embodiments, some processes or methods are further disclosed. Hereinafter, an overview of these methods is given without repeating some of details discussed above. It should be noted that although these methods are disclosed in the description of the electronic apparatuses for a network side and a terminal device side in wireless communications, the methods may not necessarily use the components as described or be performed by those components. For example, an embodiment of the electronic apparatus for a network side and a terminal device side in wireless communications may be implemented partially or entirely by using hardware and/or firmware, while a method for a network side and a terminal device side in wireless communications discussed below may be implemented entirely by a computer-executable program, although the method may employ the hardware and/or firmware for the electronic apparatus for a network side and a terminal device side in wireless communications.

FIG. 11 illustrates a flow chart of a method for a network side in wireless communications according to an embodiment of the present disclosure. The method includes: in response to an assistance request about Near Field Communication from a terminal device, determining (S11) indication information for the terminal device based on perception information; and providing (S12) the indication information to the terminal device.

For example, the assistance request is for requesting the network side to provide information required for preparing the Near Field Communication between the terminal device and another terminal device. The assistance request may include one or more of a geographic location, a planned path, a blind zone in perception, a priority level of tendency for a perception service category, and a format of the indication information for the terminal device.

The indication information includes, for example, one or more of perception information for the terminal device, information on a strategy of the Near Field Communication for the terminal device, information on a region of the Near Field Communication for the terminal device, and relevant information of another potential terminal device meeting the requirements of the terminal device.

The perception information may include one or more of raw sensor data, dynamic high-precision map, feature data or semantic data, and communication semantics or features. The strategy of the Near Field Communication may include one or more of Near Field Communication manner, an identifier of a Near Field Communication object, a priority level of the Near Field Communication object, mobility information of the Near Field Communication object, available communication time corresponding to the Near Field Communication object, expected communication quality, service content of the Near Field Communication, and requirements of the Near Field Communication. The region of the Near Field Communication may include one or more of a first target region where another terminal device suitable for conducting the Near Field Communication with the terminal device is located, boundary region information of the first target region, and a second target region where the terminal device is suitable for triggering the Near Field Communication and an upper-layer service.

In an example, the method may include predicting a strategy of the Near Field Communication and/or a region of the Near Field Communication for the terminal device based on the perception information and the assistance request by using a neural network model disposed on the network side. For example, the neural network model is trained based on sensor data from at least one of the network side, the terminal device or a third-party sensor.

The network side may include one of a core network side or a base station side. Alternatively, the network side may include one or more of a central subsystem, a roadside unit, or a multi-access edge computing platform.

The above method corresponds to the electronic apparatus 100 in the first embodiment, detailed description of which is given in the first embodiment and is not repeated here.

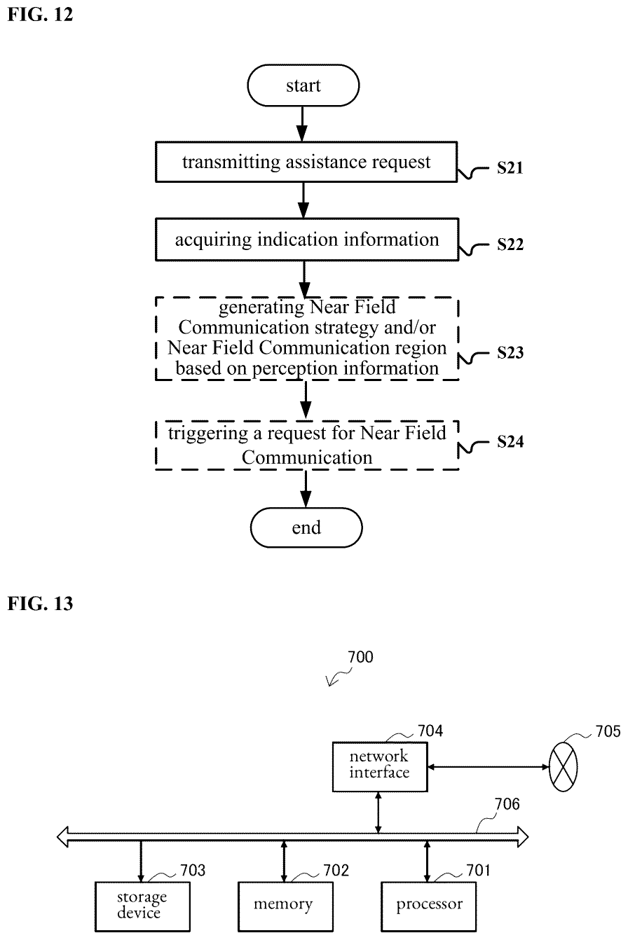

FIG. 12 illustrates a flow chart of a method for a terminal device side in wireless communications according to another embodiment of the present disclosure. The method includes: transmitting (S21) an assistance request about Near Field Communication to a network side in the wireless communications; and acquiring (S22), from the network side, indication information for the terminal device determined by the network side based on perception information in response to the assistance request.

For example, the assistance request is for requesting the network side to provide information required for preparing the Near Field Communication between the terminal device and another terminal device. For example, the assistance request may be transmitted in response to detecting that an object affecting a wireless environment is around the terminal device. The assistance request may include one or more of a geographic location, a planned path, a blind zone in perception, a priority level of tendency for a perception service category, and a format of the indication information for the terminal device.

For example, the indication information includes one or more of perception information for the terminal device, information on a strategy of the Near Field Communication for the terminal device, information on a region of the Near Field Communication for the terminal device, and relevant information of another potential terminal device meeting the requirements of the terminal device.

The perception information may include one or more of raw sensor data, dynamic high-precision map, feature data or semantic data, and communication semantics or features. The strategy of the Near Field Communication may include one or more of Near Field Communication manner, an identifier of a Near Field Communication object, a priority level of the Near Field Communication object, mobility information of the Near Field Communication object, available communication time corresponding to the Near Field Communication object, expected communication quality, service content of the Near Field Communication, and requirements of the Near Field Communication. The region of the Near Field Communication may include one or more of a first target region where another terminal device suitable for conducting the Near Field Communication with the terminal device is located, boundary region information of the first target region, and a second target region where the terminal device is suitable for triggering the Near Field Communication and an upper-layer service.

As shown in a dotted box in FIG. 12, in a case where the indication information includes perception information for the terminal device, the method further includes step S23 of generating a strategy of Near Field Communication and/or region of Near Field Communication based on the perception information by using a neural network model.

In a case where the indication information includes information on a strategy of Near Field Communication and/or information on a region of Near Field Communication for the terminal device, or in a case where the strategy of Near Field Communication and/or the region of Near Field Communication is determined by the terminal device based on the perception information, the method further includes: triggering (S24) a request for Near Field Communication with the Near Field Communication object based on the strategy of Near Field Communication and/or the region of Near Field Communication, as shown in another dotted box in FIG. 12.

The request for Near Field Communication includes, for example, one or more of a time period during which data transmission is expected to occur, an indication of direction and range of a beam and information strength, and an edge indication of Near Field Communication. The edge indication of Near Field Communication may include geographic information of an edge of a region of Near Field Communication and a communication behavior when approaching the edge, and the Near Field Communication object is configured to trigger, when reaching the edge, the communication behavior when approaching the edge. The communication behavior when approaching the edge includes, for example, one or more of disconnecting a link, sending an alarm notification, increasing transmission power, and triggering beam adjustment.

In addition, in a case where the indication information includes information of a region of Near Field Communication for the terminal device, the method further includes: preferentially determining another terminal device within the first target region as the Near Field Communication object, and/or initiating Near Field Communication with another terminal device when the terminal device is in the second target region.

Although not shown in FIG. 12, the method may further include receiving a request for Near Field Communication from another terminal device, and performing, in response to the request for Near Field Communication, at least one of determining an initial beam scanning range and a signal transmission strength for performing beam matching with the another terminal device; determining a cycle for maintaining a keep-alive procedure and a configuration of wireless air interface resources; and triggering, when reaching the edge, the communication behavior when approaching the edge according to geographical information of the edge of the region of Near Field Communication and the communication behavior when approaching the edge indicated in the request for Near Field Communication.

The method may further include receiving second indication information from another terminal device, the second indication information including relevant information of a potential terminal device meeting the requirements of the terminal device, where the second indication information is provided by the network side to the another terminal device.

The above method corresponds to the electronic apparatus 200 in the second embodiment, detailed description of which is given in the second embodiment and is not repeated here.

It is to be noted that the above methods can be used in combination or alone.

The technology of the present disclosure is applicable to various products.

For example, the electronic apparatus 100 may be implemented as any type of server, such as a tower server, a rack server, and a blade server. The electronic apparatus 100 may be a control module installed on a server (such as an integrated circuit module including a single wafer, and a card or blade inserted into a slot of a blade server).

In addition, the electronic apparatus 100 may be implemented as various base stations. The base station may be implemented as any type of evolved Node B (eNB) or gNB (5G base station). An eNB includes, for example, a macro eNB and a small eNB. The small eNB may be an eNB covering a cell smaller than a macro cell, such as a pico eNB, a micro eNB, or a home (femto) eNB. A similar situation may apply to the gNB. Alternatively, the base station may be implemented as any other type of base station, such as a NodeB or a base transceiver station (BTS). The base station may include a body (which is also referred to as a base station device) configured to control wireless communications and one or more remote radio heads (RRHs) provided at a different place from the body. In addition, various types of user equipment may serve as a base station by temporarily or semi-permanently performing functions of the base station.

The electronic apparatus 200 may be implemented as various user equipment. The user equipment may be implemented as a mobile terminal (such as a smart phone, a tablet personal computer (PC), a notebook PC, a portable game terminal, a portable/dongle-type mobile router, and a digital camera) or a vehicle-mounted terminal (such as an automobile navigation device). The user equipment may be implemented as a terminal that performs machine-to-machine (M2M) communications (which is also referred to as a machine type communication (MTC) terminal). Furthermore, the user equipment may be a wireless communication module (such as an integrated circuit module including a single wafer) installed on each of the above-mentioned terminals.

### APPLICATION EXAMPLES OF SERVER

FIG. 13 is a block diagram showing an example of a schematic configuration of a server 700 to which the technology of the present disclosure is applicable. The server 700 includes a processor 701, a memory 702, a storage device 703, a network interface 704, and a bus 706.

The processor 701 may be, for example, a central processing unit (CPU) or a digital signal processor (DSP), and controls functions of the server 700. The memory 702 includes a random-access memory (RAM) and a read-only memory (ROM), and stores data and a program executed by the processor 701. The storage device 703 may include a storage medium, such as a semiconductor memory and a hard disk.

The network interface 704 is a wired communication interface for connecting the server 700 to a wired communication network 705. The wired communication network 705 may be a core network such as an Evolved Packet Core (EPC), or a packet data network (PDN) such as the Internet.

The bus 706 connects the processor 701, the memory 702, the storage device 703, and the network interface 704 to each other. The bus 706 may include two or more buses having different speeds (such as a high-speed bus and a low-speed bus).

In the server 700 shown in FIG. 13, the determination unit 101 and the communication unit 102 of the electronic apparatus 100 may be implemented through the processor 701. For example, the processor 701 may implement the assistance in Near Field Communication based on perception information for the terminal device by executing the functions of the determination unit 101 and the communication unit 102.

### APPLICATION EXAMPLES OF BASE STATION

### First Application Example

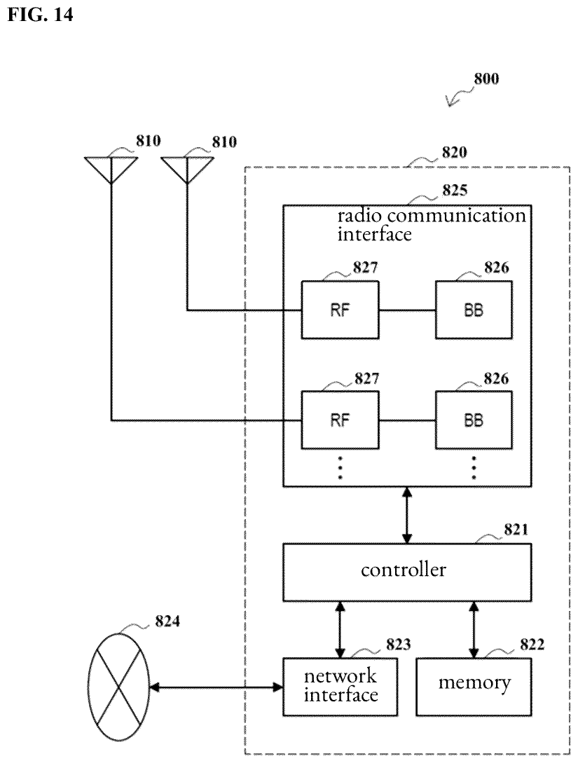

FIG. 14 is a block diagram showing a first example of a schematic configuration of an eNB or gNB to which the technology of the present disclosure is applicable. It should be noted that the following description is made taking an eNB as an example. The technology of the present disclosure also applies to a gNB. An eNB 800 includes one or more antennas 810 and a base station device 820. The base station device 820 and each of the antennas 810 may be connected to each other via a RF cable.

Each of the antennas 810 includes a single or multiple antenna elements (such as multiple antenna elements included in a multi-input multi-output (MIMO) antenna), and is used for the base station device 820 to transmit and receive wireless signals. As shown in FIG. 14, the eNB 800 may include multiple antennas 810. For example, the multiple antennas 810 may be compatible with multiple frequency bands used by the eNB 800. Although FIG. 14 shows an example in which the eNB 800 includes multiple antennas 810, the eNB 800 may include a single antenna 810.

The base station device 820 includes a controller 821, a memory 822, a network interface 823, and a radio communication interface 825.

The controller 821 may be, for example, a CPU or DSP, and operates various functions of a higher layer of the base station device 820. For example, the controller 821 generates a data packet based on data in a signal processed by the radio communication interface 825, and transfers the generated packet via the network interface 823. The controller 821 may bundle data from multiple baseband processors to generate a bundled packet, and transfer the generated bundled packet. The controller 821 may have logical functions of performing control such as radio resource control, radio bearer control, mobility management, admission control, and scheduling. The control may be performed in conjunction with a nearby eNB or a core network node. The memory 822 includes an RAM and an ROM, and stores a program executed by the controller 821 and various types of control data (such as a terminal list, transmission power data, and scheduling data).

The network interface 823 is a communication interface for connecting the base station device 820 to a core network 824. The controller 821 may communicate with the core network node or another eNB via the network interface 823. In this case, the eNB 800 and the core network node or another eNB may be connected to each other through a logical interface (such as an S1 interface and an X2 interface). The network interface 823 may be a wired communication interface or a radio communication interface for a wireless backhaul line. In a case that the network interface 823 is a radio communication interface, the network interface 823 may use a higher frequency band for wireless communications than a frequency band used by the radio communication interface 825.

The radio communication interface 825 supports any cellular communication scheme (such as Long-Term Evolution (LTE) and LTE-Advanced), and provides wireless connection to a terminal in a cell of the eNB 800 via the antenna 810. The radio communication interface 825 may typically include, for example, a baseband (BB) processor 826 and an RF circuit 827. The BB processor 826 may perform, for example, coding/decoding, modulation/demodulation and multiplexing/de-multiplexing, and perform various types of signal processes of layers (for example, L1, media access control (MAC), radio link control (RLC) and packet data convergence protocol (PDCP)). Instead of the controller 821, the BB processor 826 may have a part or all of the above-mentioned logical functions. The BB processor 826 may be a memory storing a communication control program, or a module including a processor and a related circuit configured to execute the program. Updating the program may change the functions of the BB processor 826. The module may be a card or blade inserted into a slot of the base station device 820. Alternatively, the module may be a chip mounted on the card or blade. In addition, the RF circuit 827 may include, for example, a mixer, a filter and an amplifier, and transmit and receive a wireless signal via the antenna 810.

As shown in FIG. 14, the radio communication interface 825 may include multiple BB processors 826. For example, the multiple BB processors 826 may be compatible with multiple frequency bands used by the eNB 800. As shown in FIG. 14, the radio communication interface 825 may include multiple RF circuits 827. For example, the multiple RF circuits 827 may be compatible with multiple antenna elements. Although FIG. 14 shows an example in which the radio communication interface 825 includes multiple BB processors 826 and multiple RF circuits 827, the radio communication interface 825 may include a single BB processor 826 or a single RF circuit 827.

In the eNB 800 as shown in FIG. 14, the determination unit 101, the communication unit 102 of the electronic apparatus 100 and the transceiver may be implemented through the radio communication interface 825. At least a part of the functions may be implemented by the controller 821. For example, the controller 821 may implement the assistance in Near Field Communication based on perception information for the terminal device by executing the functions of the determination unit 101 and the communication unit 102.

### Second Application Example

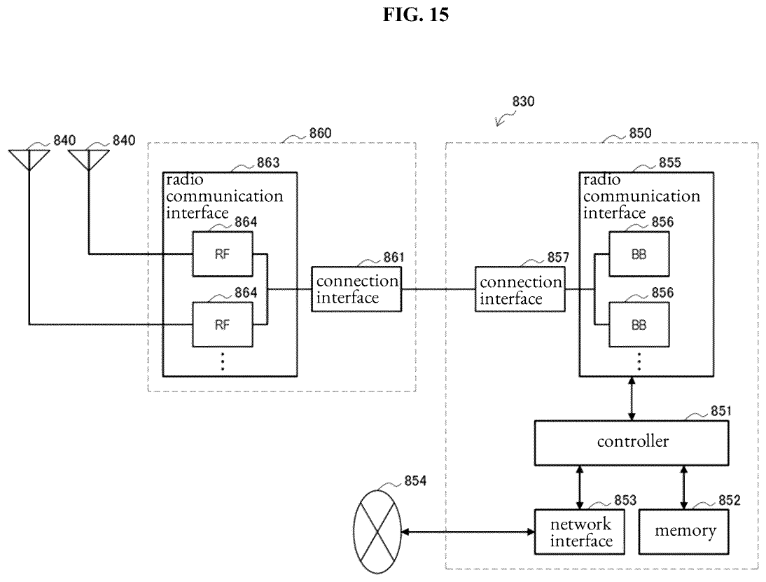

FIG. 15 is a block diagram showing a second example of a schematic configuration of an eNB or gNB to which the technology of the present disclosure is applicable. It should be noted that the following description is made taking the eNB as an example. The technology of the present disclosure also applies to the gNB. An eNB 830 includes a single or multiple antennas 840, a base station device 850 and an RRH 860. The RRH 860 and each of the antennas 840 may be connected to each other via an RF cable. The base station device 850 and the RRH 860 may be connected to each other via a high-speed line such as an optical fiber cable.

Each of the antennas 840 includes a single or multiple antenna elements (such as multiple antenna elements included in a MIMO antenna), and is used for the RRH 860 to transmit and receive a wireless signal. As shown in FIG. 15, the eNB 830 may include multiple antennas 840. For example, the multiple antennas 840 may be compatible with multiple frequency bands used by the eNB 830. Although FIG. 15 shows an example in which the eNB 830 includes multiple antennas 840, the eNB 830 may include a single antenna 840.

The base station device 850 includes a controller 851, a memory 852, a network interface 853, a radio communication interface 855, and a connection interface 857. The controller 851, the memory 852, and the network interface 853 are the same as the controller 821, the memory 822, and the network interface 823 described with reference to FIG. 14.

The radio communication interface 855 supports any cellular communication scheme (such as LTE and LTE-advanced), and provides wireless communications to a terminal located in a sector corresponding to the RRH 860 via the RRH 860 and the antenna 840. The radio communication interface 855 may typically include, for example, a BB processor 856. The BB processor 856 is the same as the BB processor 826 described with reference to FIG. 14, except that the BB processor 856 is connected to an RF circuit 864 of the RRH 860 via the connection interface 857. As shown in FIG. 15, the radio communication interface 855 may include multiple BB processors 856. For example, the multiple BB processors 856 may be compatible with multiple frequency bands used by the eNB 830. Although FIG. 15 shows an example in which the radio communication interface 855 includes multiple BB processors 856, the radio communication interface 855 may include a single BB processor 856.

The connection interface 857 is an interface for connecting the base station device 850 (the radio communication interface 855) to the RRH 860. The connection interface 857 may be a communication module for communication in the above-described high-speed line that connects the base station device 850 (the radio communication interface 855) to the RRH 860.

The RRH 860 includes a connection interface 861 and a radio communication interface 863.

The connection interface 861 is an interface for connecting the RRH 860 (the radio communication interface 863) to the base station device 850. The connection interface 861 may be a communication module for communication in the above-mentioned high-speed line.

The radio communication interface 863 transmits and receives wireless signals via the antenna 840. The radio communication interface 863 may typically include, for example, the RF circuit 864. The RF circuit 864 may include, for example, a mixer, a filter and an amplifier, and transmit and receive wireless signals via the antenna 840. As shown in FIG. 15, the radio communication interface 863 may include multiple RF circuits 864. For example, the multiple RF circuits 864 may support multiple antenna elements. Although FIG. 15 shows an example in which the radio communication interface 863 includes multiple RF circuits 864, the radio communication interface 863 may include a single RF circuit 864.

In the eNB 830 as shown in FIG. 15, the determination unit 101 and the communication unit 102 of the electronic apparatus 100 and the transceiver may be implemented through the radio communication interface 855 and/or the radio communication interface 863. At least a part of the functions may be implemented by the controller 851. For example, the controller 851 may implement the assistance in Near Field Communication based on perception information for the terminal device by executing the functions of the determination unit 101 and the communication unit 102.

### APPLICATION EXAMPLE OF USER EQUIPMENT

### First Application Example

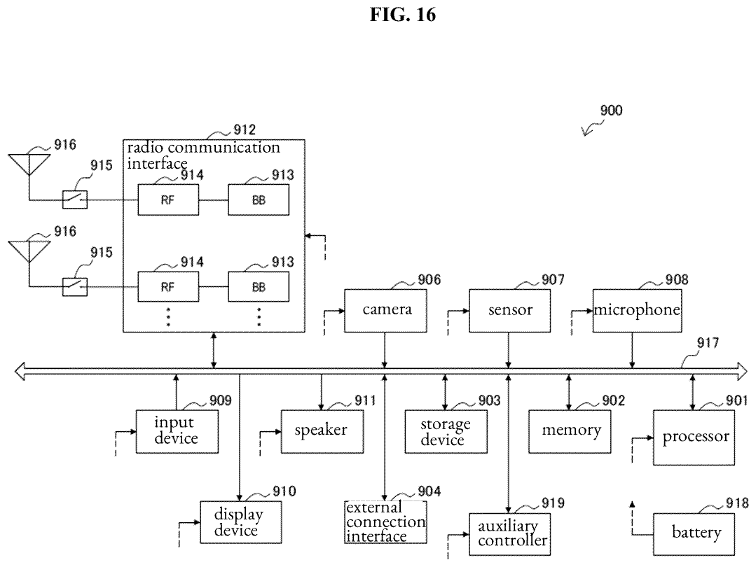

FIG. 16 is a block diagram showing an example of a schematic configuration of a smart phone 900 to which the technology of the present disclosure is applicable. The smart phone 900 includes a processor 901, a memory 902, a storage device 903, an external connection interface 904, a camera 906, a sensor 907, a microphone 908, an input device 909, a display device 910, a speaker 911, a radio communication interface 912, one or more antenna switches 915, one or more antennas 916, a bus 917, a battery 918, and an auxiliary controller 919.

The processor 901 may be, for example, a CPU or a system on chip (SoC), and controls functions of the application layer and other layers of the smart phone 900. The memory 902 includes an RAM and an ROM, and stores data and programs executed by the processor 901. The storage device 903 may include a storage medium, such as a semiconductor memory and a hard disk. The external connection interface 904 is an interface for connecting an external device (such as a memory card and a universal serial bus (USB) device) to the smart phone 900.

The camera 906 includes an image sensor (such as a charge coupled device (CCD) and a complementary metal oxide semiconductor (CMOS)), and generates a captured image. The sensor 907 may include a set of sensors, such as a measurement sensor, a gyroscope sensor, a geomagnetic sensor, and an acceleration sensor. The microphone 908 converts sound inputted to the smart phone 900 into an audio signal. The input device 909 includes, for example, a touch sensor configured to detect a touch on a screen of the display device 910, a keypad, a keyboard, a button, or a switch, and receives an operation or information inputted from a user. The display device 910 includes a screen, such as a liquid crystal display (LCD) or an organic light emitting diode (OLED) display, and displays an output image of the smart phone 900. The speaker 911 converts the audio signal outputted from the smart phone 900 into sound.

The radio communication interface 912 supports any cellular communication scheme (such as LTE and LTE-Advanced), and performs wireless communications. The radio communication interface 912 may generally include, for example, a BB processor 913 and an RF circuit 914. The BB processor 913 may perform, for example, encoding/decoding, modulation/demodulation, and multiplexing/demultiplexing, and perform various types of signal processing for wireless communications. In addition, the RF circuit 914 may include, for example, a mixer, a filter and an amplifier, and transmit and receive a wireless signal via the antenna 916. It should be noted that, although the figure shows a situation where one RF link is connected to one antenna, this is only illustrative, and a situation where one RF link is connected to multiple antennas through multiple phase shifters is also possible. The radio communication interface 912 may be a chip module on which the BB processor 913 and the RF circuit 914 are integrated. As shown in FIG. 16, the radio communication interface 912 may include multiple BB processors 913 and multiple RF circuits 914. Although FIG. 16 shows an example in which the radio communication interface 912 includes multiple BB processors 913 and multiple RF circuits 914, the radio communication interface 912 may include a single BB processor 913 or a single RF circuit 914.

In addition to the cellular communication scheme, the radio communication interface 912 may support another type of wireless communication scheme, such as a short-range wireless communication scheme, a near field communication scheme, and a wireless local area network (LAN) scheme. In this case, the radio communication interface 912 may include a BB processor 913 and an RF circuit 914 for each wireless communication scheme.

Each of the antenna switches 915 switches a connection destination of the antenna 916 among multiple circuits (for example, circuits for different wireless communication schemes) included in the radio communication interface 912.

Each of the antennas 916 includes a single or multiple antenna elements (such as multiple antenna elements included in a MIMO antenna), and is configured for the radio communication interface 912 to transmit and receive wireless signals. As shown in FIG. 16, the smart phone 900 may include multiple antennas 916. Although FIG. 16 shows an example in which the smart phone 900 includes multiple antennas 916, the smart phone 900 may include a single antenna 916.

In addition, the smart phone 900 may include antenna(s) 916 for each wireless communication scheme. In this case, the antenna switches 915 may be omitted from the configuration of the smart phone 900.

The processor 901, the memory 902, the storage device 903, the external connection interface 904, the camera 906, the sensor 907, the microphone 908, the input device 909, the display device 910, the speaker 911, the radio communication interface 912, and the auxiliary controller 919 are connected to each other via the bus 917. The battery 918 supplies power to each block of the smart phone 900 as shown in FIG. 16 via a feeder line. The feeder line is partially shown as a dashed line in the figure. The auxiliary controller 919 operates the least necessary function of the smart phone 900 in a sleep mode, for example.

In the smartphone 900 as shown in FIG. 16, the transmission unit 201 and the reception unit 202 of the electronic apparatus 200 and the transceiver may be implemented through the radio communication interface 912. At least part of the functions may be implemented by the processor 901 or the auxiliary controller 919. For example, the processor 901 or auxiliary controller 919 may obtain from the network side, the assistance in Near Field Communication based on perception information for the terminal device by executing the functions of the transmission unit 201, the reception unit 202 and the determination unit 203.

### Second Application Example

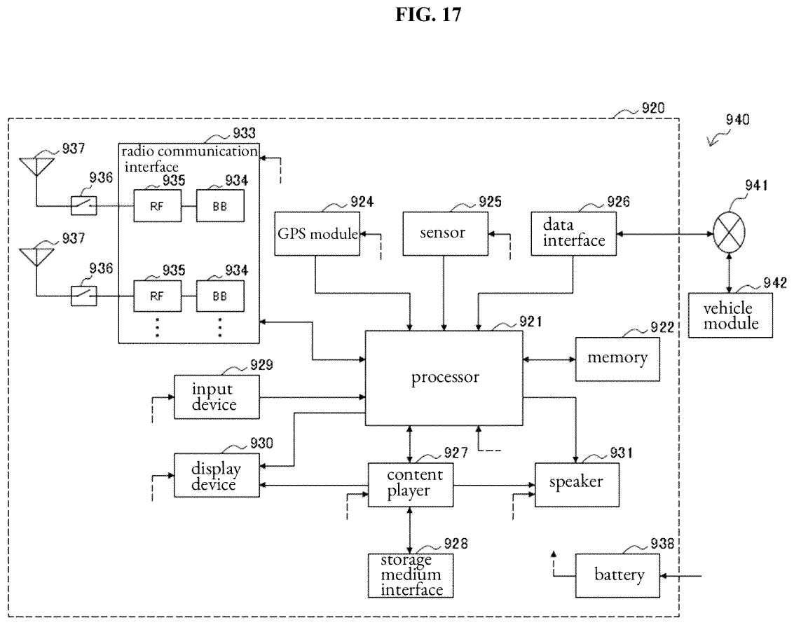

FIG. 17 is a block diagram showing an example of a schematic configuration of an automobile navigation apparatus 920 to which the technology of the present disclosure is applicable. The automobile navigation device 920 includes a processor 921, a memory 922, a global positioning system (GPS) module 924, a sensor 925, a data interface 926, a content player 927, a storage medium interface 928, an input device 929, a display device 930, a speaker 931, a radio communication interface 933, one or more antenna switches 936, one or more antennas 937, and a battery 938.

The processor 921 may be, for example, a CPU or SoC, and controls the navigation function and other functions of the automobile navigation device 920. The memory 922 includes an RAM and an ROM, and stores data and programs executed by the processor 921.

The GPS module 924 measures a position (such as latitude, longitude, and altitude) of the automobile navigation device 920 based on a GPS signal received from a GPS satellite. The sensor 925 may include a set of sensors, such as a gyroscope sensor, a geomagnetic sensor, and an air pressure sensor. The data interface 926 is connected to, for example, an in-vehicle network 941 via a terminal not shown, and acquires data (such as vehicle speed data) generated by a vehicle.

The content player 927 reproduces content stored in a storage medium (such as a CD and a DVD) inserted into the storage medium interface 928. The input device 929 includes, for example, a touch sensor configured to detect a touch on a screen of the display device 930, a button, or a switch, and receives an operation or information inputted from a user. The display device 930 includes a screen such as an LCD or OLED display, and displays an image or reproduced content of a navigation function. The speaker 931 outputs a sound or reproduced content of the navigation function.

The radio communication interface 933 supports any cellular communication scheme (such as LTE and LTE-Advanced), and performs wireless communications. The radio communication interface 933 may generally include, for example, a BB processor 934 and an RF circuit 935. The BB processor 934 may perform, for example, encoding/decoding, modulation/demodulation, and multiplexing/demultiplexing, and perform various types of signal processing for wireless communications. In addition, the RF circuit 935 may include, for example, a mixer, a filter and an amplifier, and transmit and receive a wireless signal via the antenna 937. The radio communication interface 933 may be a chip module on which the BB processor 934 and the RF circuit 935 are integrated. As shown in FIG. 17, the radio communication interface 933 may include multiple BB processors 934 and multiple RF circuits 935. Although FIG. 17 shows an example in which the radio communication interface 933 includes multiple BB processors 934 and multiple RF circuits 935, the radio communication interface 933 may include a single BB processor 934 or a single RF circuit 935.

In addition to the cellular communication scheme, the radio communication interface 933 may support another type of wireless communication scheme, such as a short-range wireless communication scheme, a near field communication scheme, or a wireless LAN scheme. In this case, the radio communication interface 933 may include a BB processor 934 and an RF circuit 935 for each wireless communication scheme.

Each of the antenna switches 936 switches a connection destination of the antenna 937 among multiple circuits (such as circuits for different wireless communication schemes) included in the radio communication interface 933.

Each of the antennas 937 includes a single or multiple antenna elements (such as multiple antenna elements included in a MIMO antenna), and is configured for the radio communication interface 933 to transmit and receive wireless signals. As shown in FIG. 17, the automobile navigation device 920 may include multiple antennas 937. Although FIG. 17 shows an example in which the automobile navigation device 920 includes multiple antennas 937, the automobile navigation device 920 may include a single antenna 937.

In addition, the automobile navigation device 920 may include antenna(s) 937 for each wireless communication scheme. In this case, the antenna switches 936 may be omitted from the configuration of the automobile navigation device 920.

The battery 938 supplies power to blocks of the automobile navigation device 920 shown in FIG. 17 via a feeder line. The feeder line is partially shown as a dashed line in the figure. The battery 938 accumulates electric power supplied from the vehicle.

In the vehicle navigation device 920 as shown in FIG. 17, the transmission unit 201 and the reception unit 202 of the electronic apparatus 200 and the transceiver may be implemented through the radio communication interface 933. At least part of the functions may be implemented by the processor 921. For example, the processor 921 may obtain from the network side, the assistance in Near Field Communication based on perception information for the terminal device by executing the functions of the transmission unit 201, the reception unit 202 and the determination unit 203.

The technology of the present disclosure may be implemented as an in-vehicle system (or vehicle) 940 including the vehicle navigation device 920, an in-vehicle network 941, and one or more blocks of vehicle modules 942. The vehicle modules 942 generate vehicle data (such as vehicle speed, engine speed, and failure information), and outputs the generated data to the in-vehicle network 941.

Basic principles of the present disclosure are described above in conjunction with specific embodiments. However, it should be noted that those skilled in the art can understand that all or any steps or components of the methods and apparatuses of the present disclosure can be implemented in any computing device (including processors, storage media, and the like) or a network of computing devices in a form of hardware, firmware, software or a combination thereof. Such implementation can be realized by those skilled in the art after reading the description of the present disclosure, by utilizing basic knowledge of circuit design or basic programming skills.

Moreover, a program product storing machine-readable instruction codes is further provided according to an embodiment of the present disclosure. The instruction codes, when read and executed by a machine, may implement the methods according to the embodiments of the present disclosure.

Accordingly, a storage medium for carrying the program product storing the machine-readable instruction codes is further included in the present disclosure. The storage medium includes, but is not limited to, a floppy disk, an optical disk, a magneto-optical disk, a storage card, a memory stick, and the like.

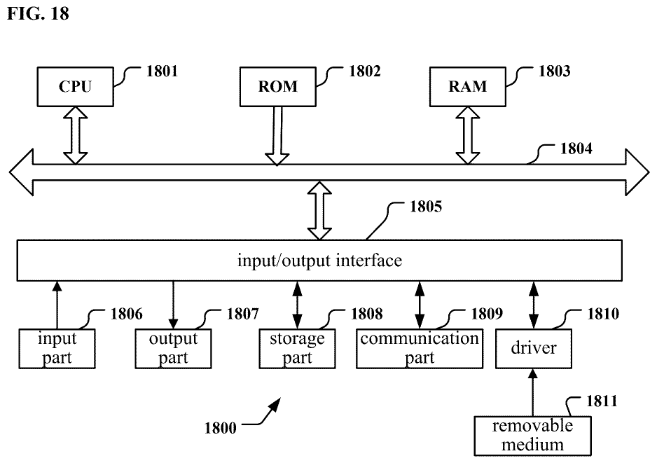

In a case of implementing the embodiments of the present disclosure in software or firmware, the program consisting of the software is mounted to a computer with a dedicated hardware structure (such as a general-purpose personal computer 1800 as shown in FIG. 18) from the storage medium or network. The computer, when mounted with various programs, performs various functions.

In FIG. 18, a central processing unit (CPU) 1801 executes various processes according to a program stored in a read-only memory (ROM) 1802 or a program loaded from a storage part 1808 to a random-access memory (RAM) 1803. In the RAM 1803, data required for the CPU 1801 to perform various processes or the like is stored as necessary. The CPU 1801, the ROM 1802 and the RAM 1803 are connected to each other via a bus 1804. An input/output interface 1805 is connected to the bus 1804.

The following components are connected to the input/output interface 1805: an input part 1806 (including a keyboard, a mouse, and the like), an output part 1807 (including a display such as a cathode ray tube (CRT) and a liquid crystal display (LCD), a loudspeaker, and the like), a storage part 1808 (including a hard disk and the like), and a communication part 1809 (including a network interface card, such as a LAN card, and a modem). The communication part 1809 performs communication processing via a network, such as the Internet. A driver 1810 may be connected to the input/output interface 1805 as needed. A removable medium 1811, such as a magnetic disk, an optical disk, a magnetic optical disk, and a semiconductor memory, is mounted to the driver 1810 as required, so that a computer program read therefrom is mounted to the storage part 1808 as required.

In a case that the above processes are implemented by software, the program consisting the software is mounted from a network, such as the Internet, or from a storage medium, such as the removable medium 1811.

Those skilled in the art should understood that, the storage medium is not limited to the removable medium 1811, as shown in FIG. 18, which stores a program and is distributed separately from the device so as to provide the program for a user. Examples of the removable medium 1811 includes a magnetic disk (including a floppy disk (registered trademark)), an optical disk (including a compact disk read-only memory (CD-ROM) and a Digital Versatile Disk (DVD)), a magneto-optical disk (including a mini disk (MD) (registered trademark)), and a semiconductor memory. Alternatively, the storage medium may be the ROM 1802, the hard disk contained in the storage part 1808, or the like. The storage medium stores a program and is distributed to the user along with an apparatus in which the storage medium is incorporated.

It should be further noted that components or steps in the apparatus, method and system of the present disclosure can be decomposed and/or recombined. Such decomposition and/or recombination should be considered equivalents of the present disclosure. Furthermore, steps for executing the above processes may naturally be executed in a chronological order as described, but do not necessarily need to be executed in the chronological order. Certain steps may be performed in parallel with or independently of each other.

Finally, it should be noted that terms “include”, “comprise” or any other variants are intended to be non-exclusive. Therefore, a process, method, article or device including a series of elements includes not only the elements but also other elements that are not enumerated, or further includes elements inherent to the process, method, article or device. In addition, unless expressively limited otherwise, the statement “comprising (including) a(n) . . . ” does not exclude existence of other identical elements in the process, method, article or device.

Although the embodiments of the present disclosure are described in detail above with reference to the accompanying drawings, it should be understood that the embodiments are only for illustrating the present disclosure and do not constitute a limitation of the present disclosure. For those skilled in the art, various modifications and changes can be made to the embodiments without departing from the essence and scope of the present disclosure. Therefore, the scope of the present disclosure is limited by only the appended claims and equivalents thereof.

1. An electronic apparatus for a network side in wireless communications, comprising:
at least one processor; and
at least one memory including computer program code, where the at least one memory and the computer program code are configured, with the at least one processor, to cause the electronic apparatus to at least:
in response to an assistance request about Near Field Communication from a terminal device, determine indication information for the terminal device based on perception information; and
provide the indication information to the terminal device.

2. The electronic apparatus according to claim 1, wherein the assistance request is for requesting the network side to provide information required for preparing the Near Field Communication between the terminal device and another terminal device, and
wherein the assistance request comprises one or more of a geographic location, a planned path, a blind zone in perception, a priority level of tendency for a perception service category, and a format of the indication information for the terminal device.

3. (canceled)

4. The electronic apparatus according to claim 1, wherein the indication information comprises one or more of perception information for the terminal device, information on a strategy of the Near Field Communication for the terminal device, information on a region of the Near Field Communication for the terminal device, and relevant information of another potential terminal device meeting requirements of the terminal device.

5. The electronic apparatus according to claim 4, wherein the perception information comprises one or more of raw sensor data, dynamic high-precision map, feature data or semantic data, and communication semantics or features,
wherein the strategy of the Near Field Communication comprises one or more of Near Field Communication manner, an identifier of a Near Field Communication object, a priority level of the Near Field Communication object, mobility information of the Near Field Communication object, available communication time corresponding to the Near Field Communication object, expected communication quality, service content of the Near Field Communication, and requirements of the Near Field Communication, and
wherein the region of the Near Field Communication comprises one or more of a first target region where another terminal device suitable for conducting the Near Field Communication with the terminal device is located, boundary region information of the first target region, and a second target region where the terminal device is suitable for triggering the Near Field Communication and an upper-layer service.

6.-7. (canceled)

8. The electronic apparatus according to claim 4, wherein the at least one memory and the computer program code are configured, with the at least one processor, to cause the electronic apparatus further to predict the strategy of the Near Field Communication and/or the region of the Near Field Communication for the terminal device based on the perception information and the assistance request by using a neural network model disposed on the network side.

9. The electronic apparatus according to claim 8, wherein the neural network model is trained based on sensor data from at least one of the network side, the terminal device or a third-party sensor.

10. The electronic apparatus according to claim 1, wherein the network side comprises one of a core network side and a base station side, or
the network side comprises one or more of a central subsystem, a roadside unit, or a multi-access edge computing platform.

11. An electronic apparatus for a terminal device side in wireless communications, comprising:
at least one processor; and
at least one memory including computer program code, where the at least one memory and the computer program code are configured, with the at least one processor, to cause the electronic apparatus to at least:
transmit an assistance request about Near Field Communication to a network side in the wireless communications; and
acquire, from the network side, indication information for the terminal device which is determined by the network side based on perception information in response to the assistance request.

12. The electronic apparatus according to claim 11, wherein the assistance request is for requesting the network side to provide information required for preparing the Near Field Communication between the terminal device and another terminal device, and
wherein the assistance request comprises one or more of a geographic location, a planned path, a blind zone in perception, a priority level of tendency for a perception service category, and a format of the indication information for the terminal device.

13. (canceled)

14. The electronic apparatus according to claim 11, wherein the indication information comprises one or more of perception information for the terminal device, information on a strategy of the Near Field Communication for the terminal device, information on a region of the Near Field Communication for the terminal device, and relevant information of another potential terminal device meeting requirements of the terminal device.

15. The electronic apparatus according to claim 14, wherein the perception information comprises one or more of raw sensor data, dynamic high-precision map, feature data or semantic data, and communication semantics or features,
wherein the strategy of the Near Field Communication comprises one or more of a Near Field Communication manner, an identifier of a Near Field Communication object, a priority level of the Near Field Communication object, mobility information of the Near Field Communication object, available communication time corresponding to the Near Field Communication object, expected communication quality, service content of the Near Field Communication, and requirements of the Near Field Communication, and
wherein the region of the Near Field Communication comprises one or more of a first target region where another terminal device suitable for conducting the Near Field Communication with the terminal device is located, boundary region information of the first target region, and a second target region where the terminal device is suitable for triggering the Near Field Communication and an upper-layer service.

16.-17. (canceled)

18. The electronic apparatus according to claim 14, wherein in a case where the indication information comprises perception information for the terminal device, the at least one memory and the computer program code are configured, with the at least one processor, to cause the electronic apparatus further to generate the strategy of Near Field Communication and/or the region of Near Field Communication based on the perception information by using a neural network model.

19. The electronic apparatus according to claim 14, wherein in a case where the indication information comprises the information on the strategy of Near Field Communication and/or the information on the region of Near Field Communication for the terminal device, the at least one memory and the computer program code are configured, with the at least one processor, to cause the electronic apparatus further to trigger a request for Near Field Communication with a Near Field Communication object based on the strategy of Near Field Communication and/or the region of Near Field Communication.

20. The electronic apparatus according to claim 19, wherein the request for Near Field Communication comprises one or more of a time period during which data transmission is expected to occur, an indication of direction and range of a beam and information strength, and an edge indication of Near Field Communication.

21. The electronic apparatus according to claim 20, wherein the edge indication of Near Field Communication comprises geographic information of an edge of the region of Near Field Communication and a communication behavior when approaching the edge, and the Near Field Communication object is configured to trigger, when reaching the edge, the communication behavior when approaching the edge.

22. The electronic apparatus according to claim 21, wherein the communication behavior when approaching the edge comprises one or more of disconnecting a link, sending an alarm notification, increasing transmission power, and triggering beam adjustment.

23. The electronic apparatus according to claim 15, wherein in a case where the indication information comprises the information on the region of Near Field Communication for the terminal device, the at least one memory and the computer program code are configured, with the at least one processor, to cause the electronic apparatus further to preferentially determine another terminal device within the first target region as an Near Field Communication object, and/or the processing circuitry is configured to initiate Near Field Communication with another terminal device when the terminal device is in the second target region.

24. The electronic apparatus according to claim 19, wherein the at least one memory and the computer program code are configured, with the at least one processor, to cause the electronic apparatus further to receive a request for Near Field Communication from another terminal device, and perform, in response to the request for Near Field Communication, at least one of:
determining an initial beam scanning range and a signal transmission strength for performing beam matching with the another terminal device;
determining a cycle for maintaining a keep-alive procedure and a configuration of wireless air interface resources; and
triggering, when reaching an edge, the communication behavior when approaching the edge, according to geographical information of an edge of the region of Near Field Communication and a communication behavior when approaching the edge indicated in the request for Near Field Communication.

25. The electronic apparatus according to claim 11, wherein the at least one memory and the computer program code are configured, with the at least one processor, to cause the electronic apparatus further to transmit the assistance request in response to detecting that an object affecting a wireless environment is around the terminal device.

26. The electronic apparatus according to claim 11, wherein the at least one memory and the computer program code are configured, with the at least one processor, to cause the electronic apparatus further to receive second indication information from another terminal device, the second indication information comprising relevant information of a potential terminal device meeting the requirements of the terminal device, and wherein the second indication information is provided by the network side to the other terminal device.

27.-29. (canceled)
